(19) United States
(12) Patent Application Publication
(10) Pub. No.: US 2014/0127357 A1
(43) Pub. Date: May 8, 2014

(54) Method of Manufacturing Artichoke Tea

(71) Applicant: TAIWAN TIAN JIAN BIOTECHNOLOGY CO. LTD., Nantou County (TW)

(72) Inventor: Kuo-Hsin Liao, Nantou County (TW)

(73) Assignee: TAIWAN TIAN JIAN BIOTECHNOLOGY CO. LTD., Nantou County (TW)

(21) Appl. No.: 13/671,536

(22) Filed: Nov. 7, 2012

(51) Int. Cl. A23F 3/06

(52) U.S. Cl. 426/49

(57) ABSTRACT

The present invention provides a method of manufacturing artichoke tea comprising the steps of separating leaf stems, drying the leaf stems at low temperature and performing fermentation, forced-ripening and sugar-preserving processes on the leaf stems of the artichoke. The present invention utilizes the separation to remove the leaves from the leaf stems of the artichoke such that the origin of the taste of bitterness is removed along with the leaves. The leaf stems of the artichoke further undergo drying and fermentation processes such that the water is removed therefrom while preserving the nutrients of the artichoke therein. The forced-ripening and the sugar-preserving processes are further applied to the leaf stems to facilitate the transformation and preservation of the fruitafit-inulin thereof in order to produce a taste of sweetness. The manufactured artichoke tea of the present invention produces no bitterness taste while having nutrients thereof being preserved with enhanced sweet flavor.

### TECHNICAL FIELD OF THE INVENTION

The present invention is related to a method of manufacturing a tea, in particular, to a method of manufacturing an artichoke tea.

### DESCRIPTION OF THE PRIOR ART

Since the eighteenth century, artichoke has been seen as a luxury ingredient to be served in higher class dishes for French nobles. However, as there are various limitations to the growing and cultivating of high quality artichoke, it is mostly being prepared and cooked as a vegetable dish or being produced as freshly extracted juices or extraction pills for desirable consumptions. Experimental research data has also shown that artichoke is not only famous for its fresh and unique taste that impresses the people including the ones of higher social classes but is also helpful and useful to the human health including the effects of stimulating the bile secretion, protecting and caring the liver, lowering the cholesterol level and preventing the gallstones from occurring. In addition, artichoke is often used as a necessary supplement in a diet meal during such period of dieting. Therefore, artichoke is being widely used in various applications recently.

In addition to the direct making of freshly extracted juice from artichoke, it has also been made into tea bags for tea drinkers and lovers to enjoy its unique flavor and taste with great convenience. Such tea bags are not only made for easy preservation but are also with the merits of excellent portability and convenience for brewing. Conventionally, in western countries, during the making of tea, the leafs and leaf stems of the artichoke are dried and produced altogether with the buds, which is likely to produce a taste of bitterness in the tea brewed from the tea bag and may not be desirable to most tea drinkers. In the country of Vietnam, it is known that the production and extraction of the nutrients, such as tea seeds, from the artichoke generally involve the addition of momordica to increase the sweetness; however, the artichoke tea bags produced in such way are of much less nutrients since they have been extracted during the production, which makes such kind of tea bags for flavor and tastes only without the aforementioned healthy effects.

### SUMMARY OF THE INVENTION

A primary objective of the present invention is to provide a method of manufacturing an artichoke tea with a greater taste and preserved nutrients such that the drawback associated with the known technique utilized in conventional manufacturing of artichoke teas having bitterness tastes affecting the consumption of tea drinkers and the problem of losing nutrients from the artichoke tea during the conventional manufacturing process can be overcome such that an artichoke tea manufactured by the method of the present invention has no bitterness taste and with preserved nutrients therein for health purposes.

To achieve the abovementioned objective, the present invention provides a method of manufacturing an artichoke tea, comprising the following steps of:

S1: separating a leaf stem from a leaf of an artichoke by removing said leaf but retaining said leaf stem;

S2: drying said leaf stem at a low temperature for a period of drying time, followed by cooling said leaf stem without a machine operation for a period of cooling time to facilitate a fermentation process to be carried out afterwards;

S3: placing said leaf stem into a cooking wok for said fermentation process; wherein said fermentation process is carried out at a first temperature;

S4: performing a forced-ripening process to cook said leaf stem at a second temperature; wherein said second temperature is greater than said first temperature; and

S5: performing a sugar-preserving process to cook said leaf stem at a third temperature; wherein said third temperature is greater than said second temperature.

In view of the above, the method of manufacturing an artichoke tea of the present invention comprises the step of removing the leaf from the artichoke but retaining the leaf stem thereof for further processes of tea making. The leaf stems then undergo a drying process at a low temperature followed by a fermentation process such that the water in the leaf stems is removed and the nutrients of the artichoke are preserved in the leaf stems. Furthermore, the leaf stems then undergo a forced-ripening process and a sugar-preserving process such that the nutrient of frutafit-inulin in the leaf stem is being transformed and well preserved in the completely manufactured leaf stem. With such method of manufacturing of an artichoke tea provided by the present invention, the manufactured artichoke tea is not only preserved with its original and unique artichoke flavors but also with the taste of bitterness being removed while the artichoke nutrients are well preserved such that the manufactured artichoke tea is of a greater taste and healthy nutrients.

### BRIEF DESCRIPTION OF THE DRAWINGS

FIG. 1 is a flow chart illustrating the first embodiment of the manufacturing method of the present invention.

### DETAILED DESCRIPTION OF THE PREFERRED EMBODIMENTS

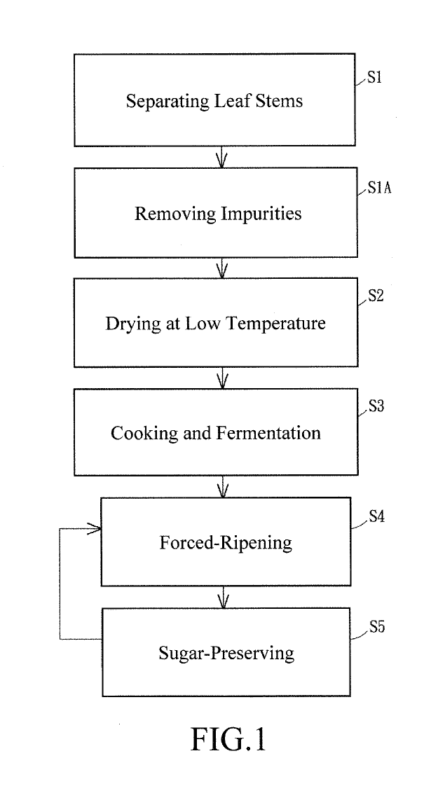

FIG. 1 shows a flow chart of a first embodiment of a method of manufacturing an artichoke tea. As shown in the figure, the present invention provides a method of manufacturing an artichoke tea, comprising the following steps of:

S1: Separating a leaf stem from a leaf of an artichoke by removing said leaf but retaining said leaf stem. Experimental data and research results have shown that the taste of bitterness of the artichoke tea is mainly originated from the leaves of the artichoke. Furthermore, the nutrient of frutafit-inulin is mostly stored or preserved in the leaf stems of the artichoke. Therefore, the present invention provides a manufacturing method of the artichoke tea by separating the leaves from the leaf stems of the artichoke while retaining only the leaf stems thereof for further fermentation process in the making of the artichoke tea such that the origins of the taste of bitterness is removed to increase the unique sweetness of the artichoke tea.

S1A: Removing impurities after the previous separation of said leaf from said leaf stems in the abovementioned step with a cleaning process of removing fur and dust from the leaf stem to clean off the leaf stem in order to maintain the purity and cleanness of the manufactured artichoke tea.

S2: cutting said leaf stem obtained in the previous step into pieces for further drying process at a low temperature; and wherein said pieces of said leaf stem being cut are of a length, preferably, between 0.8˜1.3 mm, which is then followed by drying said leaf stem at a low temperature for a period of drying time to remove the water in the leaf stem. After such period of drying time at the low temperature, said leaf stem is further cooled without a machine operation for a period of cooling time to facilitate a fermentation process to be carried out afterwards. In addition, it shall be noted that the period of drying time is preferably between 7˜9 hours, and the period of cooling time is preferably between 9˜11 hours.

S3: Placing said leaf stem into a cooking wok for a fermentation process; wherein said fermentation process is carried out at a first temperature for a period of time preferably between 15˜25 minutes; and wherein said first temperature is preferably between 80˜100° C. such that the water in the leaf stem is further removed to facilitate the fermentation process of the leaf stem of the artichoke being cut into pieces and obtained previously.

S4: Performing a forced-ripening process to cook said leaf stem at a second temperature for a period of time preferably between 10˜15 minutes; wherein said second temperature is greater than said first temperature. As an exemplary example, the second temperature is preferably between 110˜135° C. With such step, the nutrients of the artichoke can be extracted and preserved in the leaf stems thereof such that the nutrients can be released during the brewing of the artichoke tea and such that the transformation of the fruitafit-inulin preserved in the leaf stems is also facilitated.

S5: Performing a sugar-preserving process to cook said leaf stem at a third temperature for a period of time preferably between 2˜5 minutes; wherein said third temperature is greater than said second temperature. Preferably, the third temperature is between 160˜220° C. in order to prevent the overcooking and scorching of the tea during the cooking thereof. It is preferably to increase the temperature rapidly when step S5 is to be performed after step S4 such that the second temperature is increased to the third temperature in a fast rate. Via such step, the transformed fruitafit-inulin can be further melted and well preserved in the leaf stems of the artichoke in order to allow the fruitafit-inulin to be released during the brewing of the artichoke tea, making such artichoke tea with a greater taste of sweetness and unique flavor.

Upon the completion of the abovementioned step, in order to further remove or force the water out of the leaf stems of the artichoke as well as to facilitate the transformation of the fruitafit-inulin and the preservation of the sugar thereof, said step S4 and said step S5 are preferably repeated at least two more times such that the quality of the artichoke tea is further enhanced.

In view of the above, the method of manufacturing an artichoke tea of the present invention utilizes the step of removing the leaf from the artichoke but retaining the leaf stem thereof such that the taste of bitterness in the conventionally artichoke tea of known arts can be eliminated. In addition, as the leaf stems of the artichoke undergo the drying process at a low temperature followed by the fermentation process, the water in the leaf stems of the artichoke can be removed and the nutrients can be advantageously preserved in the leaf stems. Furthermore, the forced-ripening process and the sugar-preserving process applied to the making of the artichoke tea greatly facilitate the transformation of the nutrient of frutafit-inulin in the leaf stems for its better preservation in the completely manufactured leaf stem, which too enhances the sweetness and unique flavor of the manufactured artichoke tea of the present invention. In addition, as the method of manufacturing of an artichoke tea of the present invention is controlled with precise timing and temperatures in different processes involved, the uniqueness of the flavor of the manufactured artichoke tea via such manufacturing method can be greatly enhanced and such that the manufactured artichoke tea of the present invention is of a greater taste. The present invention provides not only a novel method of manufacturing an artichoke tea but also one with an inventive step having advantages over known arts as fully described and submitted for its merits complying with the requirements for a patent.

What is claimed is:

1. A method of manufacturing an artichoke tea, comprising the following steps of
S1: separating a leaf stem from a leaf of an artichoke by removing said leaf but retaining said leaf stem;
S2: drying said leaf stem at a low temperature for a period of drying time, followed by cooling said leaf stem without a machine operation for a period of cooling time to facilitate a fermentation process to be carried out afterwards;
S3: placing said leaf stem into a cooking wok for said fermentation process; wherein said fermentation process is carried out at a first temperature;
S4: performing a forced-ripening process to cook said leaf stem at a second temperature; wherein said second temperature is greater than said first temperature; and
S5: performing a sugar-preserving process to cook said leaf stem at a third temperature; wherein said third temperature is greater than said second temperature.

2. The method of manufacturing an artichoke tea according to claim 1, wherein said step S2 further comprises a step of cutting said leaf stem into pieces prior to said step of drying at low temperature.

3. The method of manufacturing an artichoke tea according to claim 2, wherein said pieces of said leaf stem being cut are of a length between 0.8˜1.3 mm.

4. The method of manufacturing an artichoke tea according to claim 2, wherein said period of drying time is between 7˜9 hours; and said period of cooling time is between 9˜11 hours.

5. The method of manufacturing an artichoke tea according to claim 1, wherein said first temperature is between 80˜100° C.; said second temperature is between 110˜135° C.; and said third temperature is between 160˜220° C.

6. The method of manufacturing an artichoke tea according to claim 1, wherein said step S3 is controlled to be performed for a operation time between 15˜25 minutes; said step S4 is performed for a operation time between 10˜15 minutes; and said step S5 is performed for a operation time between 2˜5 minutes.

7. The method of manufacturing an artichoke tea according to claim 1, wherein upon a completion of said step S5, said step S4 and said step S5 are repeated at least two more times.

8. The method of manufacturing an artichoke tea according to claim 1, further comprises a cleaning step prior to said step S2: removing fur and dust from said leaf stem to clean off said leaf stem.
